(19) United States
(12) Patent Application Publication
(10) Pub. No.: US 2002/0085253 A1
(43) Pub. Date: Jul. 4, 2002

(54) Switchable optical add/drop device and method using the same

(76) Inventors: Yale Zhang, Sunnyvale, CA (US); Jian Wu, Palo Alto, CA (US)

Correspondence Address: Peter C. Chang, Alliance Fiber Optics Products, Inc., 735 North Pastoria Avenue, Sunnyvale, CA, 94086, US

(21) Appl. No.: 09/750,737

(22) Filed: Dec. 29, 2000

(51) Int. Cl. G02B 6/28; H04J 14/02

(52) U.S. Cl. 359/127; 385/24

(57) ABSTRACT

A switchable optical add/drop device (1) includes a first R-channel (20) and a second R-channel (30) opposite to each other. A first path (70) and second path (80) are respectively defined between two near ends and two far ends of the first R-channel (20) and the second R-channel (30). A first collimator (40) with an ADD port (42) and a second collimator (52) with a DROP port (52) are disposed about said first R-channel (2) and said second R-channel (30). A prism (60) is removable disposed among the R-channels (20, 30) and the collimators (40, 50) for switchably adding/dropping the specific wavelength channel.

### BACKGROUND OF THE INVENTION

1. Field of the Invention

The invention relates to fiber optic communication systems, and particularly to the method of switchably or re-configurably adding/dropping the specific single wavelength channel to/from the multiplex of input wavelengths, and the associated device using the same.

2. The Related Art

The optical ADD/DROP multiplexer is mainly used to add and drop one or more wavelength channels at a network node in a fiber optic communication system. With the increasing demands on the fiber optic communication systems, the optical network has been widely used in smaller systems, such as the local telephone or data networks, after proving its success on long haul point to point networks. It is noted that in the smaller system, communication signals are usually transmitted over a limited geographic area to various nodes into the network. A particular node can be re-configured to drop one or more channels from multiple channels, and/or add one or more channels with new information to the transmitted signals for transmission to other nodes in the network.

Current optical ADD/DROP devices are essentially passive components and lack availability of switching and power control thereof. To achieve the re-configuration capability, a 2×2 switch or two 1×2 switches are used to control the ADD and DROP port(s). This method and the corresponding device can be found in all the suppliers in the market. However, all the popularly used methods have disadvantages of uneven power distribution for the through and dropped channels.

Therefore, an object of the invention is to provide a new method for switchably or re-configurably add/drop channels to/from the transmitted signal of multiplex wavelength channels, and the corresponding device thereof. Therefore, one can use the device to specifically add and/or drop the selected channels, or allow all the channels to pass through with minimum insertion loss thereof.

### SUMMARY OF THE INVENTION

According to an aspect of the invention, a switchable optical ADD/DROP device includes first and second same R-channel modules opposite to each other, two collimators performing in-and-out functions respectively, and a removable prism to commonly define switchable optical path. The R-channel module includes a GRIN lens with a DWDM filter. The multiplexed signal enters the first R-channel module with the specific wavelength channel passing through the filter and along a firstpath directing toward the second R-channel from the one side with the filter thereon while the rest of wavelength channels being reflected to a second path which enters the second R-channel from the other side opposite to the corresponding filter. The prism is adapted to be in a first position where the prism blocks the first path and guide the filtered/dropped specific wavelength channel toward the DROP collimator while simultaneously guide another added specific wavelength channel, if any, from the ADD collimator toward the filter side of the second collimator for entering the second collimator. Under this condition, the added wavelength channel will join the rest of wavelength channels from the second path to leave the second collimator via the OUT port. Alternatively, when the prism is moved to a second position without blocking the first path, the filter wavelength channel will enter the second collimator from the filter side, and join the rest of wavelength channels from the second path, leaving the second collimator via the OUT port. Therefore, the device essentially integrates the switching function and the optical ADD/DROP function together.

### BRIEF DESCRIPTION OF THE DRAWINGS

FIG. 1 is a diagram to show a switchable optical ADD/DROP device according to the invention.

FIG. 2 is a diagram to show the R-channel used in FIG. 1.

### DETAILED DESCRIPTION OF THE PREFERRED EMBODIMENTS

References will now be in detail to the preferred embodiments of the invention. While the present invention has been described in with reference to the specific embodiments, the description is illustrative of the invention and is not to be construed as limiting the invention. Various modifications to the present invention can be made to the preferred embodiments by those skilled in the art without departing from the true spirit and scope of the invention as defined by appended claims.

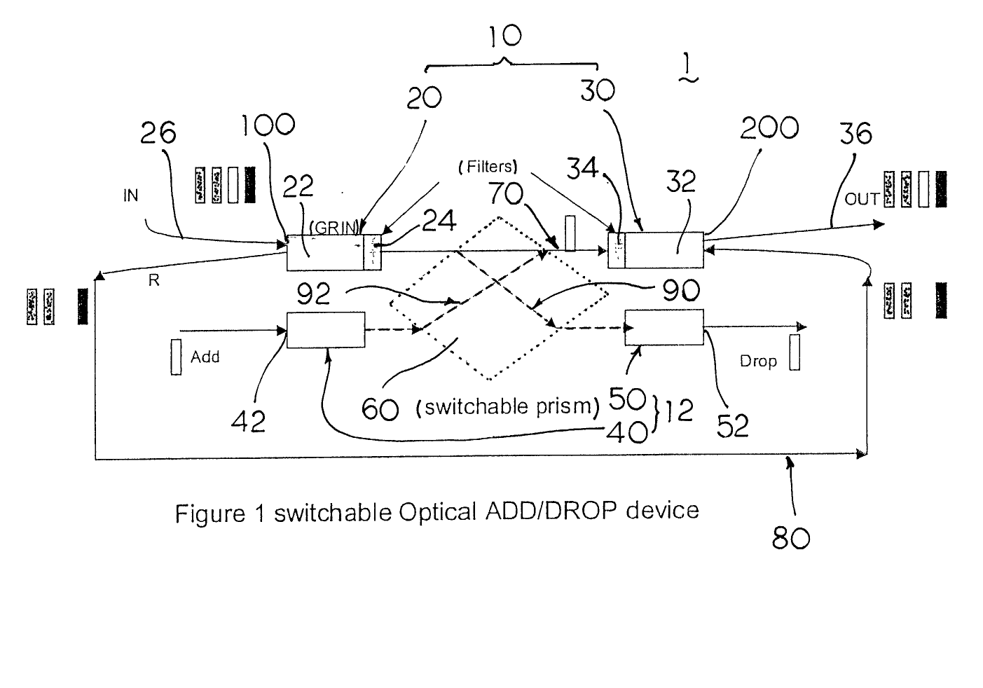

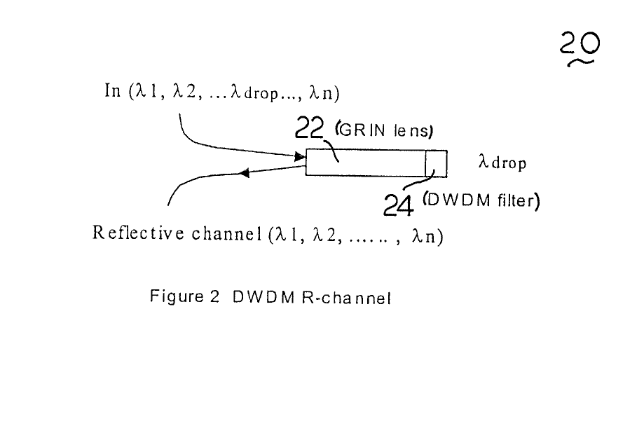

It will be noted here that for a better understanding, most of like components are designated by like reference numerals throughout the various figures in the embodiments. Attention is directed to FIGS. 1 and 2 wherein a switchable optical ADD/DROP device 1 generally comprises the R-channel assembly 10, the collimator assembly 12 and the switchable prism 60. The R-channel assembly 10 includes a first R-channel 20 and a second R-channel 30 spatially opposite to each other. The first R-channel 20 includes a GRIN lens 22 and a DWDM filter 24. A first optical fiber 26 enters the IN port 100 of the first R-channel 20, and a first path 70 is defined on the filter side (the near end) of the R-channel 20 toward the second R-channel 30 and a second path 80 is defined on the same side (the far end) of the IN port 100.

Similarly, the second R-channel 30 includes a GRIN lens 32 and a DWDM filter 34 which is same with the DWDM filter 24. A second optical fiber 36 is connected to the OUT port 200 of the second R-channel 30. The first path 70 enters the second R-channel 30 through the filter 34, and the second path 80 enters the second R-channel 30 on the same side of the OUT port 200.

The collimator 12 includes a first collimator 40 and an opposite second collimator 50 being disposed around the first R-channel 20 and the second R-channel 30, wherein the first collimator 40, which is generally located on the same side of the first R-channel 20, defines an ADD port 42, and the second collimator 50, which is generally located on the same side of the second R-channel 30, defines a DROP port 52.

A switchable prism 60 is removeably positioned among the first R-channel 20, the second R-channel 30, the first collimator 40, and the second collimator 50.

Therefore, in the condition of removal of the switchable prism 60 among the R-channel assembly 10 and the collimator assembly 12, a multiplexed signal enters the first R-channel 20 from the IN port 100 with a specific wavelength channel penetrates the filter 24 to the first path 70, while the rest of the wavelength channels are reflected to the second path 80 and directed to the second R-channel 30 around the side of the OUT port 200. The filtered specific wavelength channel along the first path 70 further penetrates the filter 34 of the second R-channel 30, entering the second R-channel 30 and further joining the rest of the wavelength channels from the second path 80, then leaving the second R-channel 30 via the OUT port 200. It is noted that under this situation the whole assembly functions as a transmission device without any change.

Differently, in the condition of positioning/existence of the switchable prism 60, the filtered specific wavelength channel from the first R-channel 20 will hit the switchable prism 60 and be directed, along the dotted line path 90, to the second collimator 50 and dropped from the DROP port 52. Simultaneously, the same wavelength channel with new information signal may be added through the ADD port 40 of the first collimator 40 and hit the switchable prism 60 and be guided, along the dotted line path 92, to the second R-channel 30. The newly added wavelength channel penetrates the second filter 34 and joins the rest of the wavelength channels from the second path 80 and leaves the second R-channel 30 via the OUT port 200. Under this situation, the whole assembly functions as a switchable ADD/DROP device.

In brief, if the prism 60 is present, the device 1 drops a single wavelength (λ_{drop}) to the DROP port 52 through the prism 60. In the mean time, the same wavelength (λ_{add}) can be added through the ADD port 80. In opposite if the prism 60 is removed, the dropped wavelength passes the second identical DWDM filter 34 and combined with the through channels from the second path 80. In this case, the device 1 does not affect the spectra of the channels. Therefore, no wavelength is dropped or added. This is the so-called by pass mode.

The features and the advantages of the invention are as follows.

(1) The invention achieves the low insertion loss, the uniform bypass mode, even power distribution, the compact size, and the lower cost.

(2) The invention integrates the switch and optical add/drop function in a single piece. Understandably, the prism used in the invention is one feasible embodiment, and thus other means having the switching function may be applied thereto substitutionally.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

Therefore, person of ordinary skill in this field are to understand that all such equivalent structures are to be included in the scope of the following claims.

We claim:

1. A switchable optical add/drop device comprising:
a DWDM R-channel assembly;
a collimator assembly; and
a switching device removeably positioned therebetween so as to optionally perform a by-pass mode or an add/drop function.

2. The device as defined in claim 1, wherein said R-channel assembly includes first and second R-channels spatially opposite to each other.

3. The device as defined in claim 2, wherein the first R-channel includes
a first GRIN lens, the first DWDM filter, and a first fiber connected to
an IN port of said first R-channel, and the second R-channel includes
a second GIN lens, a second DWDM filter, and a second fiber connected to an OUT port of said second R-channel.

4. The device as defined in claim 3, wherein said first R-channel and said second R-channel are structurally the same.

5. The device as defined in claim 4, wherein said first R-channel and said second R-channel are face to face disposed with each other with said first filter and said second filter confronting each other.

6. The device as defined in claim 4, wherein a first path is defined between the first filter and the second filter for passage of the filtered wavelength channel.

7. The device as defined in claim 4, wherein a second path is defined between said first R-channel and said second R-channel, said second path being connected to the first R-channel on the same side of the IN port and to the second R-channel on the same side of the OUT port.

8. The device as defined in claim 1, wherein the collimator assembly includes first and second collimator respectively defining ADD and DROP ports.

9. The device as defined in claim 1, wherein said switching device is a prism.

10. The device as defined in claim 1, wherein said prism blocks signal ways of the R-channel assembly and of the collimator assembly and forms the switchable paths therein for switching.

11. A switchable optical add/drop device comprising:
first and second DWDM R-channels functioning as IN and OUT ports, respectively;
first and second collimators functioning as ADD and DROP ports, respectively; and
a switching device removably disposed among said first and second R-channels and said first and second collimators so that the device functions as a switchable add/drop device with existence of the switching device while functions as a by-pass mode with removal of said switching device.

12. The device as defined in claim 11, wherein said first and second DWDM R-channels are substantially structurally same with each other each with a GRIN lens and a DWDM filter for the same specific wavelength channel.

13. The device as defined in claim 11, wherein said first R-channel and said first collimator are arranged on one side of said switching device, and the second R-channel and said second collimator are arranged on the other side of said switching device.

14. The device as defined in claim 13, wherein said switching device is a prism.

15. A method of optionally switchably adding/dropping channels of a signal, comprising the steps of:
(1) providing first and second R-channels spatially opposite to each other, said first R-channel defining an IN port and said second R-channel defining an OUT port;
(2) defining a first path between two near ends of said first and second R-channels, and a second path between two far ends of said first and second R-channels;
(3) providing first and second collimators with ADD and DROP ports, respectively; and
(4) removably positioning a switching device among said first and second R-channels and said first and second collimators for blocking the first path as a switchable optical add/drop device or for not block the first path as a by-pass mode.

16. The method as defined in claim 15, wherein said switching device defines two switching path respectively guiding a filtered wavelength channel from the first path and an added wavelength channel from the first collimator.

17. The method as defined in claim 15, wherein said first and second R-channels are substantially structurally the same with the same filter thereof for the same specific wavelength channel.

18. An arrangement of switchably adding/dropping wavelength channels with regard to a multiplex signal, comprising:
a first path for transmitting a specific wavelength channel;
a second path for transmitting the rest of the wavelength channels in said multiplex signal and directing to an OUT port;
a third path for either switching the filtered specific wavelength channel in the first path to a DROP port or adding the specific wavelength channel from an ADD port to the first path.

19. The arrangement as defined in claim 18, wherein said first path is defined between two near ends of first and second R-channels, and said second path is defined between two far ends of said first and second R-channels.

20. The arrangement as defined in claim 18, wherein said third path is defined by a switching device.

21. A subassembly of a switchable optical add/drop device comprising:
a first R-channel including a first GRIN lens and a first DWDM filter;
a first fiber connected to the first GRIN lens opposite to the first DWDM filter and functioning as an IN port;
a second R-channel including a second GRIN lens and a second DWDM filter;
a second fiber connected to the second GRIN lens opposite to the second DWDM filter and functioning as an OUT port;
said first R-channel and said second R-channel being face to face disposed with each other with the first filter and the second filter confronting each other;
a first path defined between the first filter and the second filter; and
a second path defined between the first GRIN lens and the second GRIN lens around the IN and OUT ports; whereby said subassembly may cooperate with a removable switching device to switchably add/drop the specific wavelength channel or perform a by-pass mode with minimum insertion loss.

22. The subassembly as defined in claim 20, wherein said first filter and said second filter are same.

23. The subassembly as defined in claim 20, wherein said first R-channel and said second R-channel are substantially structurally same with each other.
